(19) United States
(12) Patent Application Publication
(10) Pub. No.: US 2012/0081040 A1
(43) Pub. Date: Apr. 5, 2012

(54) LIGHT EMITTING DIODE DRIVING CIRCUIT

(75) Inventor: CHIN-LONG KU, Tu-Cheng (TW)

(73) Assignee: FOXCONN TECHNOLOGY CO., LTD., Tucheng City (TW)

(21) Appl. No.: 12/954,912

(22) Filed: Nov. 29, 2010

(30) Foreign Application Priority Data
Sep. 30, 2010 (CN) 201010298247.8

(51) Int. Cl. H05B 37/02

(52) U.S. Cl. 315/362

(57) ABSTRACT

A light emitting diode driving circuit comprising a power supply circuit, a rectifier circuit, a light emitting diode load and a controlling circuit. The rectifier circuit is connected between the power supply circuit and one port of the light emitting diode load. The other port of the light emitting diode load is connected to ground through a transistor. of the controlling circuit. The power supply circuit, the rectifier circuit, the light emitting diode load are connected to the ground when the transistor is turned on and disconnected from the ground when the transistor is turned off. The controlling circuit further comprises a pulse generating unit which controls the turn on/off of the transistor.

### BACKGROUND

1. Technical Field

The present disclosure generally relates to light emitting diode driving circuits.

2. Description of Related Art

Nowadays, light emitting diodes (LEDs) have been used extensively as light source for illuminating devices due to their high luminous efficiency and low power consumption. In view of currently popularized energy saving and emission reduction, it would be much satisfied to provide an LED illuminating device equipped with a power saving driving circuit.

Therefore, what is needed is to provide a power saving driving circuit for an LED illuminating device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the whole view.

FIG. 1 is a block diagram of a light emitting diode driving circuit of the present disclosure.

FIG. 2 is a circuit diagram of the light emitting diode driving circuit in accordance with an exemplary embodiment of the present disclosure.

FIG. 3 is a circuit diagram of the light emitting diode driving circuit in accordance with an alternative embodiment of the present disclosure.

### DETAILED DESCRIPTION

Reference will now be made to the drawing to describe the present light emitting diode driving circuit, in detail.

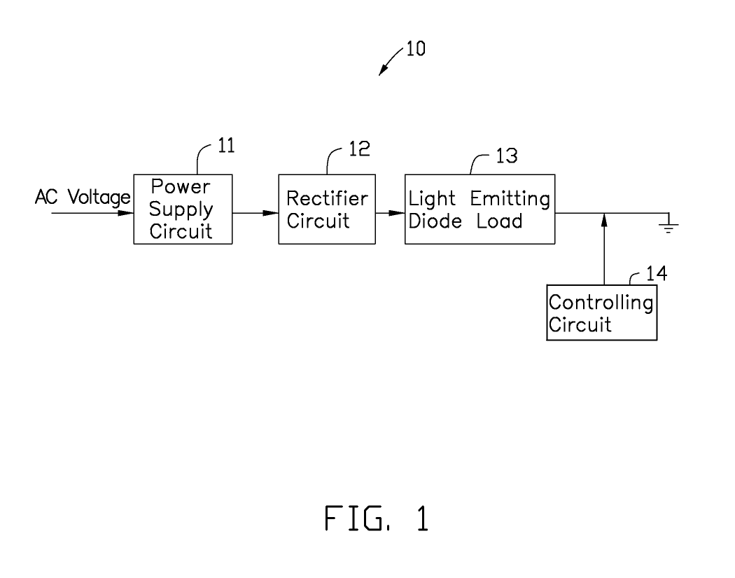

Referring to FIG. 1, a light emitting diode (LED) driving circuit 10 according to an exemplary embodiment includes a power supply circuit 11, a rectifier circuit 12, a light emitting diode load 13 and a controlling circuit 14.

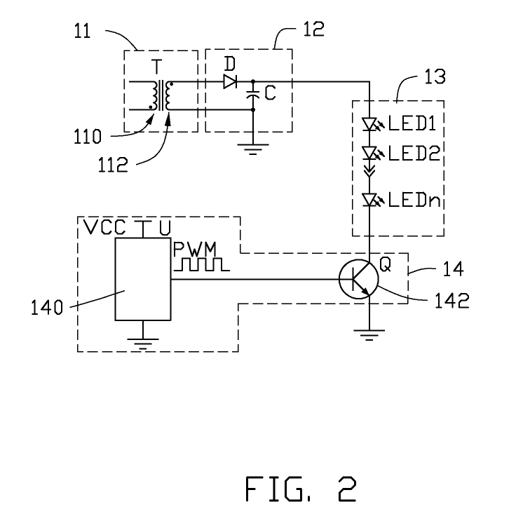

The power supply circuit 11 is configured for receiving an alternating current voltage, and converting the alternating current voltage into a working voltage suitable for the light emitting diode load 13. Referring to FIG. 2, in this embodiment, the power supply circuit 11 includes a voltage transformer “T” with a primary winding 110 and a secondary winding 112. The primary winding 110 is connected to an exterior power supply, thereby receiving an alternating current voltage. The secondary winding 112 is configured for generating the working voltage in condition of receiving an electromagnetic excitation from the primary winding 110, and output the working voltage to the rectifier circuit 12. The voltage value generated by the secondary winding 112 can be adjusted according to winding turns ratio of the primary winding 110 and the secondary winding 112.

The rectifier circuit 12 is connected to the secondary winding 112. The rectifier circuit 12 rectifies the work voltage outputted by the secondary winding 112 and successively transforms the work voltage to the light emitting diode load 13 into a form of direct current voltage. In this embodiment, the rectifier circuit 12 includes a rectifier diode “D”. An anode of the rectifier diode “D” is connected to the secondary winding 112, and a cathode of the rectifier diode “D” is connected to the light emitting diode load 13. The rectifier circuit 12 can further include a capacitor “C” connected between the cathode of the rectifier diode “D” and ground. The capacitor “C” is configured for filtering noise of the work voltage.

The light emitting diode load 13 includes a plurality of light emitting diodes “LED1”, “LED2”, . . . , “LEDn”, for receiving the work voltage and emitting light. The plurality of light emitting diodes can be connected together in series connection, parallel connection or series-parallel connection. In the shown embodiment, the light emitting diodes “LED1”, “LED2”, . . . , “LEDn” are connected together in series connection.

The controlling circuit 14 is configured for controlling the light emitting diode load 13 to emit light periodically. In this embodiment, the controlling circuit 14 includes a pulse generating unit 140 and a switch unit 142.

The pulse generating unit 140 is connected to the switch unit 142 and configured for outputting a periodical pulse signal to the switch unit 142. In this embodiment, the pulse generating unit 140 is a frequency oscillator “U”. The frequency oscillator “U” is connected to the switch unit 142, thereby outputting a pulse width modulation (PWM) signal to the switch unit 142.

The switch unit 142 is configured for receiving the pulse signal output by the pulse generating unit 140. In condition that the pulse signal has a high electrical level, the switch unit 142 switches on the electrical connection between the light emitting diode load 13 and the ground. In condition that the pulse signal has a low electrical level, the switch unit 142 switches off the electrical connection between the light emitting diode load 13 and the ground. As such, the light emitting diode load 13 emits light periodically according to the electrical level of the pulse signal output by the pulse generating unit 140. In this embodiment, the switch unit 142 includes a bipolar transistor “Q”. A base terminal of the bipolar transistor “Q” is connected to an output port of the switch unit 142, thereby receiving the pulse signal output by the pulse generating unit 140. A collector terminal of the bipolar transistor “Q” is connected to the light emitting diode load 13. An emitter terminal of the bipolar transistor “Q” is connected to the ground.

When the frequency oscillator “U” outputs a high electrical level to the base terminal of the bipolar transistor “Q”, the bipolar transistor “Q” is in a conductive state. The light emitting diode load 13 is connected to the ground by the collector terminal and the emitter terminal of the bipolar transistor “Q”. As such, the power supply circuit 11, the rectifier circuit 12, the light emitting diode load 13 and the ground together form a closed loop, and hence, the light emitting diode load 13 emits light.

When the frequency oscillator “U” outputs a low electrical level to the base terminal of the bipolar transistor “Q”, the bipolar transistor “Q” is in a cut off state. Electrical connection between the light emitting diode load 13 and the ground is cut off. As such, the light emitting diode load 13 doesn't emit light.

Accordingly, the light emitting diode load 13 periodically emits light with a frequency in accordance with the pulse signal of the frequency oscillator “U”. As long as the frequency of the pulse signal is at least 50 hertz, the periodical turn on/off of the light emitting diode load 13 will not influence human visual sense of the light generated thereby.

Due to that the light emitting diode load 13 doesn't emit light all the time, the work time is reduces and effect of power saving is achieved.

Furthermore, the power supply circuit 11, the rectifier circuit 12, the light emitting diode load 13 and the controlling circuit 14 each can have a variety of configurations only if it is capable of achieving the above described function.

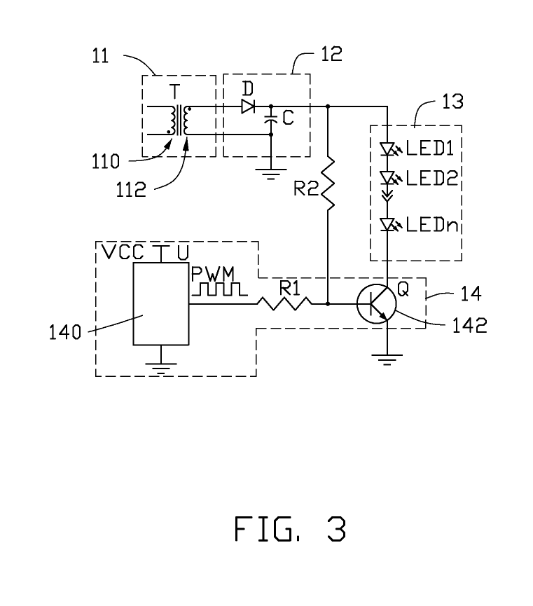

For example, referring to FIG. 3, the base terminal of the bipolar transistor “Q” can be connected to the output port of the pulse generating unit 140 by a resistor R1, and be connected to the cathode of the rectifier diode “D” by a resistor R2.

In condition that the pulse generating unit 140 has a low level output, the frequency oscillator “U” connects the base terminal of the bipolar transistor “Q” to ground through the resistor R1, thereby making the bipolar transistor “Q” be in a cut off state. As such, the power supply circuit 11, the rectifier circuit 12, the light emitting diode load 13 and the ground together can't form a closed loop, and hence, the light emitting diode load 13 doesn't emit light.

In condition that the pulse generating unit 140 has a high level output, the frequency oscillator “U” cuts off the connection between the base terminal of the bipolar transistor “Q” and ground, and the resistor R2 connected to the rectifier diode “D” provides a high level output to the bipolar transistor “Q”. As such, the bipolar transistor “Q” is in a conductive state. The power supply circuit 11, the rectifier circuit 12, the light emitting diode load 13 and the ground together form a closed loop, and hence, the light emitting diode load 13 emits light. Due to that the bipolar transistor “Q” is driven by a high electrical level provided by the rectifier circuit 12 instead of the pulse signal provided by the pulse generating unit 140, the circuit configuration illustrated in FIG. 3 is much stable than that of FIG. 2.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A light emitting diode driving circuit comprising:
a power supply circuit configured for receiving an AC voltage from an exterior power supply to adjust the AC voltage to a required AC voltage;
a rectifier circuit in connection with the power supply circuit and converting the required AC voltage into a DC voltage;
a light emitting diode load in connection with the rectifier circuit and emitting light when the light emitting diode is driven by the DC voltage; and
a controlling circuit in connection with the light emitting diode load and ground wherein the controlling circuit controls a periodical connection between the light emitting diode load and the ground whereby the light emitting diode emits light by the DC voltage and disconnection between the light emitting diode load and the ground whereby the light emitting diode load does not emit light.

2. The light emitting diode driving circuit according to claim 1, wherein the controlling circuit comprises a pulse generating unit and a switch unit, the pulse generating unit output a pulse signal to the switch unit, the switch unit is connected between the light emitting diode load and the ground, and the switch unit conducts/cuts off the connection between the light emitting diode load and the ground in condition of receiving a high/low electrical level of the pulse signal.

3. The light emitting diode driving circuit according to claim 2, wherein the pulse generating unit is a frequency oscillator with an output port connected to the switch unit.

4. The light emitting diode driving circuit according to claim 2, wherein the switch unit comprises a transistor, a base terminal of the transistor is connected to the pulse generating unit thereby receiving the pulse signal, a collector terminal of the transistor is connected to the light emitting diode load, and an emitter terminal of the transistor is connected to the ground.

5. The light emitting diode driving circuit according to claim 4, wherein a first resistor is connected between the base terminal of the transistor and the pulse generating unit.

6. The light emitting diode driving circuit according to claim 4, wherein the power supply circuit comprises a voltage transformer with a primary winding and a secondary winding, the primary winding is configured for being connected to the exterior power supply, and the secondary winding is connected to the rectifier circuit.

7. The light emitting diode driving circuit according to claim 6, wherein the rectifier circuit comprises a rectifier diode with an anode connected to the secondary winding and a cathode connected to the light emitting diode load.

8. The light emitting diode driving circuit according to claim 7, wherein the rectifier circuit further comprises a capacitor connected between the cathode of the rectifier diode and ground.

9. The light emitting diode driving circuit according to claim 8, wherein a second resistor is connected between the cathode of the rectifier diode and the base terminal of the transistor.
